(19) United States
(12) Patent Application Publication
(10) Pub. No.: US 2009/0093892 A1
(43) Pub. Date: Apr. 9, 2009

(54) Automatic determination of the order of a polynomial regression model applied to abnormal situation prevention in a process plant

(75) Inventors: Ravi Kant, Savage, MN (US); John P. Miller, Eden Prairie, MN (US)

Correspondence Address: MARSHALL, GERSTEIN & BORUN LLP (FISHER), 233 SOUTH WACKER DRIVE, 6300 SEARS TOWER, CHICAGO, IL, 60606, US

(73) Assignee: FISHER-ROSEMOUNT SYSTEMS, INC., Austin, TX (US)

(21) Appl. No.: 11/973,165

(22) Filed: Oct. 5, 2007

(51) Int. Cl. G05B 13/04

(52) U.S. Cl. 700/29

(57) ABSTRACT

A system for preventing abnormal situations in process plants is provided. A polynomial regression model is employed to predict values of a monitored variable based on measured samples of a load variable. An abnormal situation is detected when a predicted value of the monitored variable differs from a measured value of the monitored variable by more than a predetermined amount. The system employs one or more algorithms for automatically determining an optimal order or degree of the polynomial regression model.

### FIELD OF THE DISCLOSURE

The present disclosure relates generally to abnormal situation prevention in a process plant. More particularly, the disclosure relates to automatically determining the order of a polynomial regression model modeling a process control variable as a function of one or more other process control variables.

### BACKGROUND

Process control systems, like those used in chemical, petroleum or other processes, typically include one or more centralized or decentralized process controllers communicatively coupled to at least one host or operator workstation and to one or more process control and instrumentation devices such as, for example, field devices, via analog, digital or combined analog/digital buses. Field devices, which may be, for example, valves, valve positioners, switches, transmitters, and sensors (e.g., temperature, pressure, and flow rate sensors), are located within the process plant environment, and perform functions within the process such as opening or closing valves, measuring process parameters, increasing or decreasing fluid flow, etc. Smart field devices such as field devices conforming to the well-known FOUNDATION™ Fieldbus (hereinafter “fieldbus”) protocol or the HART® protocol may also perform control calculations, alarming functions, and other control functions commonly implemented within the process controller.

The process controllers, which are typically located within the process plant environment, receive signals indicative of process measurements or process variables made by or associated with the field devices and/or other information pertaining to the field devices, and execute controller applications. The controller applications implement, for example, different control modules that make process control decisions, generate control signals based on the received information, and coordinate with the control modules or blocks being performed in the field devices such as HART® and fieldbus field devices. The control modules in the process controllers send the control signals over the communication lines or signal paths to the field devices, to thereby control the operation of the process.

Information from the field devices and the process controllers is typically made available to one or more other hardware devices such as, for example, operator workstations, maintenance workstations, personal computers, handheld devices, data historians, report generators, centralized databases, etc. to enable an operator or a maintenance person to perform desired functions with respect to the process such as, for example, changing settings of the process control routine, modifying the operation of the control modules within the process controllers or the smart field devices, viewing the current state of the process or of particular devices within the process plant, viewing alarms generated by field devices and process controllers, simulating the operation of the process for the purpose of training personnel or testing the process control software, diagnosing problems or hardware failures within the process plant, etc.

While a typical process plant has many process control and instrumentation devices such as valves, transmitters, sensors, etc. connected to one or more process controllers, there are many other supporting devices that are also necessary for or related to process operation. These additional devices include, for example, power supply equipment, power generation and distribution equipment, rotating equipment such as turbines, motors, etc., which are located at numerous places in a typical plant. While this additional equipment does not necessarily create or use process variables and, in many instances, is not controlled or even coupled to a process controller for the purpose of affecting the process operation, this equipment is nevertheless important to, and ultimately necessary for proper operation of the process.

As is known, problems frequently arise within a process plant environment, especially a process plant having a large number of field devices and supporting equipment. These problems may take the form of broken, malfunctioning or underperforming devices, plugged fluid lines or pipes, logic elements, such as software routines, being improperly configured or being in improper modes, process control loops being improperly tuned, one or more failures in communications between devices within the process plant, etc. These and other problems, while numerous in nature, generally result in the process operating in an abnormal state (i.e., the process plant being in an abnormal situation) which is usually associated with suboptimal performance of the process plant. Many diagnostic tools and applications have been developed to detect and determine the cause of problems within a process plant and to assist an operator or a maintenance person to diagnose and correct the problems once the problems have occurred and been detected. For example, operator workstations, which are typically connected to the process controllers through communication connections such as a direct or a wireless bus, an Ethernet, a modem, a phone line, and the like, have processors and memories that are adapted to run software or firmware, such as the DeltaV™ and Ovation™ control systems, sold by Emerson Process Management, wherein the software includes numerous control module and control loop diagnostic tools. Likewise, maintenance workstations, which may be connected to the process control devices, such as field devices, via the same communication connections as the controller applications, or via different communication connections, such as OPC connections, handheld connections, etc., typically include one or more applications designed to view maintenance alarms and alerts generated by field devices within the process plant, to test devices within the process plant and to perform maintenance activities on the field devices and other devices within the process plant. Similar diagnostic applications have been developed to diagnose problems within the supporting equipment within the process plant.

Thus, for example, the AMS™ Suite: Intelligent Device Manager application (at least partially disclosed in U.S. Pat. No. 5,960,214 entitled “Integrated Communication Network for use in a Field Device Management System”) sold by Emerson Process Management, enables communication with and stores data pertaining to field devices to ascertain and track the operating state of the field devices. In some instances, the AMS™ application may be used to communicate with a field device to change parameters within the field device, to cause the field device to run applications on itself such as, for example, self-calibration routines or self-diagnostic routines, to obtain information about the status or health of the field device, etc. This information may include, for example, status information (e.g., whether an alarm or other similar event has occurred), device configuration information (e.g., the manner in which the field device is currently or may be configured and the type of measuring units used by the field device), device parameters (e.g., the field device range values and other parameters), etc. Of course, this information may be used by a maintenance person to monitor, maintain, and/or diagnose problems with field devices.

Similarly, many process plants include equipment monitoring and diagnostic applications such as, for example, Machinery Health™ applications provided by CSI, or any other known applications used to monitor, diagnose, and optimize the operating state of various rotating equipment. Maintenance personnel usually use these applications to maintain and oversee the performance of rotating equipment in the plant, to determine problems with the rotating equipment, and to determine when and if the rotating equipment must be repaired or replaced. Similarly, many process plants include power control and diagnostic applications such as those provided by, for example, the Liebert and ASCO companies, to control and maintain the power generation and distribution equipment. It is also known to run control optimization applications such as, for example, real-time optimizers (RTO+), within a process plant to optimize the control activities of the process plant. Such optimization applications typically use complex algorithms and/or models of the process plant to predict how inputs may be changed to optimize operation of the process plant with respect to some desired optimization variable such as, for example, profit.

These and other diagnostic and optimization applications are typically implemented on a system-wide basis in one or more of the operator or maintenance workstations, and may provide preconfigured displays to the operator or maintenance personnel regarding the operating state of the process plant, or the devices and equipment within the process plant. Typical displays include alarming displays that receive alarms generated by the process controllers or other devices within the process plant, control displays indicating the operating state of the process controllers and other devices within the process plant, maintenance displays indicating the operating state of the devices within the process plant, etc. Likewise, these and other diagnostic applications may enable an operator or a maintenance person to retune a control loop or to reset other control parameters, to run a test on one or more field devices to determine the current status of those field devices, to calibrate field devices or other equipment, or to perform other problem detection and correction activities on devices and equipment within the process plant.

While these various applications and tools are very helpful in identifying and correcting problems within a process plant, these diagnostic applications are generally configured to be used only after a problem has already occurred within a process plant and, therefore, after an abnormal situation already exists within the plant. Unfortunately, an abnormal situation may exist for some time before it is detected, identified and corrected using these tools, resulting in the suboptimal performance of the process plant for the period of time before which the problem is detected, identified and corrected. In many cases, a control operator will first detect that some problem exists based on alarms, alerts or poor performance of the process plant. The operator will then notify the maintenance personnel of the potential problem. The maintenance personnel may or may not detect an actual problem and may need further prompting before actually running tests or other diagnostic applications, or performing other activities needed to identify the actual problem. Once the problem is identified, the maintenance personnel may need to order parts and schedule a maintenance procedure, all of which may result in a significant period of time between the occurrence of a problem and the correction of that problem, during which time the process plant runs in an abnormal situation generally associated with the sub-optimal operation of the plant.

Additionally, many process plants can experience an abnormal situation which results in significant costs or damage within the plant in a relatively short amount of time. For example, some abnormal situations can cause significant damage to equipment, the loss of raw materials, or significant unexpected downtime within the process plant if these abnormal situations exist for even a short amount of time. Thus, merely detecting a problem within the plant after the problem has occurred, no matter how quickly the problem is corrected, may still result in significant loss or damage within the process plant. As a result, it is desirable to try to prevent abnormal situations from arising in the first place, instead of simply trying to react to and correct problems within the process plant after an abnormal situation arises.

One technique collects data that enables a user to predict the occurrence of certain abnormal situations within a process plant before these abnormal situations actually arise or shortly after they arise, with the purpose of taking steps to prevent the predicted abnormal situation or to correct the abnormal situation before any significant loss within the process plant takes place. This procedure is disclosed in U.S. patent application Ser. No. 09/972,078, now U.S. Pat. No. 7,085,610, entitled “Root Cause Diagnostics” (based in part on U.S. patent application Ser. No. 08/623,569, now U.S. Pat. No. 6,017,143). The entire disclosures of both of these applications/patents are incorporated herein by reference. Generally speaking, this technique places statistical data collection and processing blocks or statistical processing monitoring (SPM) blocks, in each of a number of devices, such as field devices, within a process plant. The statistical data collection and processing blocks collect, for example, process variable data and determine certain statistical measures associated with the collected data, such as a mean, a median, a standard deviation, etc. These statistical measures may then be sent to a user interface or other processing device and analyzed to recognize patterns suggesting the actual or future occurrence of a known abnormal situation. Once a particular suspected abnormal situation is detected, steps may be taken to correct the underlying problem, thereby avoiding the abnormal situation in the first place.

Many abnormal situation prevention algorithms rely on some type of regression to model a certain monitored variable as a function of some other load variable. The regression model may be calculated during a training phase in which a set of training data comprising a number of corresponding samples of the load variable and the monitored variable are analyzed to derive a function or curve that best fits the data in the training set. Once the regression model has been calculated the model may be used to predict values of the monitored variable based on measured values of the load variable received during a monitoring phase. The predicted values of the monitored variable may be compared to corresponding measured values of the monitored variable. An abnormal situation may be detected when a predicted value of the monitored variable differs from a corresponding measured value of the monitored variable by more than a predetermined amount.

In many abnormal situation prevention applications, a polynomial regression model is used. The polynomial function modeling the data may be a first order polynomial (linear), a second order polynomial (quadratic), a third order polynomial (cubic), a fourth order polynomial, and so forth. In theory there is no upper limit on the order or degree of the polynomial function. However, practical considerations such as processing time may impose some upper limit on the order of the polynomial. For example, in many applications it may be desirable to set an upper limit pₘₐₓ on the order of the polynomial. Pₘₐₓ may be, for example, an integer value between 5 and 10.

In general, the higher the order of the polynomial, the better the polynomial regression model will fit the data in the training set. It is possible, however, to “over fit” the data. In this case, the resulting polynomial function may describe the data in training set very accurately, but may otherwise miss broader more important trends in the data and may not accurately predict values of the monitored variable based on data received in the future monitoring phase. In this case, a lower order polynomial regression may actually be more accurate in predicting values of the monitored variable based on future sampled values of the load variable.

Typically the order of the polynomial regression is a configurable parameter that may be determined by the person setting up the abnormal situation prevention function. Selecting an improper value for the order of the polynomial regression may result in poor results. If the polynomial regression model fails to accurately predict values of the monitored variable based on received samples of the load variable, abnormal situations may be detected when none exists, or abnormal situations that do exist may not be detected. Thus, the person setting up the abnormal situation prevention function must have a thorough understanding of the process and of the statistical analysis underlying the abnormal situation prevention algorithm. If not, it is likely that a polynomial regression of a less than optimal order will be selected, resulting in sub-optimal performance of the abnormal situation prevention system. To avoid this situation, systems and methods are needed for automatically determining an optimal order of a polynomial regression. Such systems and methods should be capable of analyzing a set of training data and determining the proper order of a polynomial regression for the best results in predicting future values of the monitored variable based on future samples of the load variable.

### SUMMARY OF THE DISCLOSURE

The present disclosure relates to abnormal situation prevention in a process plant. Polynomial regression models are generated to model various monitored process variables as a function of one or more load variables. The models may be used to predict values of a monitored variable based on measured values of a corresponding load variable. An abnormal situation may be detected if a measured value of the monitored variable differs from a corresponding predicted value of the monitored variable by more than a predetermined amount. The regression model is calculated based on a set of training data comprising a plurality of data samples including measured values of the monitored variable and the load variable. The regression model may comprise a polynomial function of a particular order. For example, the regression curve may be linear function (1^{st} order), and quadratic function (2^{nd} order), a cubic function (3^{rd} order), and so forth. The present disclosure relates to systems and methods for automatically determining the optimal order or degree of a polynomial regression for modeling a monitored or dependent variable as a function of a load or independent variable.

According to an embodiment, a process control system includes at least one field device. At least one field device is adapted to measure a first process control variable and a second process control variable. A processor is adapted to determine the optimal order of a polynomial regression for modeling the second process control variable as a function of the first process control variable based on a plurality of corresponding values of the first and second process control variables contained in training data set. According to an embodiment the processor may execute a cross-validation algorithm for determining the optimal order of the polynomial regression. In another embodiment the processor may execute a penalty function for determining the optimal order of the polynomial regression. In still another embodiment, the processor may execute a forward selection algorithm for determining the optimal order of the polynomial regression. In yet another embodiment the processor may be adapted to determine the optimal order of the polynomial regression by calculating a polynomial regression for all polynomial orders between and including a first order polynomial and a predetermined maximum polynomial order. The processor may then calculate an R² value for each of the polynomial regression. The R² values indicate how well each polynomial fits the process control data. The optimal polynomial order may be determined by comparing the R² values of the various polynomials. Finally, the processor may utilize a support vector machine model to determine the optimal order of a polynomial regression. However the optimal order of the polynomial regression is determined, the processor adapted to determine the optimal order of the polynomial regression may be implemented in a process control field device, in a field device interface module, within a FOUNDATION™ fieldbus function block or transducer block, in a process control system such as Ovation™ or DeltaV™, or in a stand alone software application.

Another embodiment may comprise a method of creating a polynomial regression model of process control data for preventing abnormal situations in a controlled process. In this case, the method includes receiving a set of training data. The training data comprises a plurality of first process control variable values and a plurality of corresponding second process control variable values. The method further includes determining an optimal order of a polynomial regression for modeling the second process control variable as a function of the first process control variable based on the values of the first process control variable and the second process control variable included in the received set of training data. Finally, the method calls for creating a polynomial regression model of the determined order for modeling the second process control variable as a function of the first process control variable. The step of determining the optimal order of the polynomial regression may comprise performing a cross validation algorithm on the received set of training data. Alternatively, the optimal order of the polynomial regression may be determined by minimizing a penalized risk function, such as a Ridge Regression. In another alternative, the optimal order of the polynomial regression may be determined by executing a forward selection algorithm, or by comparing R² values for a plurality of polynomial regressions of every order from a first order polynomial regression to a predetermined maximum order polynomial regression.

Further aspects and advantages will be apparent to those of ordinary skill in the art from a review of the following detailed description, taken in conjunction with the drawings. While the compositions and methods are susceptible of embodiments in various forms, the description hereafter includes specific embodiments with the understanding that the disclosure is illustrative, and is not intended to limit the invention to the specific embodiments described herein.

### BRIEF DESCRIPTION OF THE DRAWINGS

FIG. 1 is an exemplary block diagram of a process plant having a distributed control and maintenance network including one or more operator and maintenance workstations, controllers, field devices and supporting equipment;

FIG. 2 is an exemplary block diagram of a portion of the process plant of FIG. 1, illustrating communication interconnections between various components of an abnormal situation prevention system located within different elements of the process plant;

FIG. 3 is an example of an abnormal situation prevention system utilizing one or more regression models;

FIG. 4 is an example of a first order regression model fitted to a set of training data;

FIG. 5 is an example of a sixth order polynomial that over-fits a set of training data;

FIG. 6 is an example of a support vector machine regression.

FIG. 7 is an example of an ε-insensitive loss function.

### DETAILED DESCRIPTION

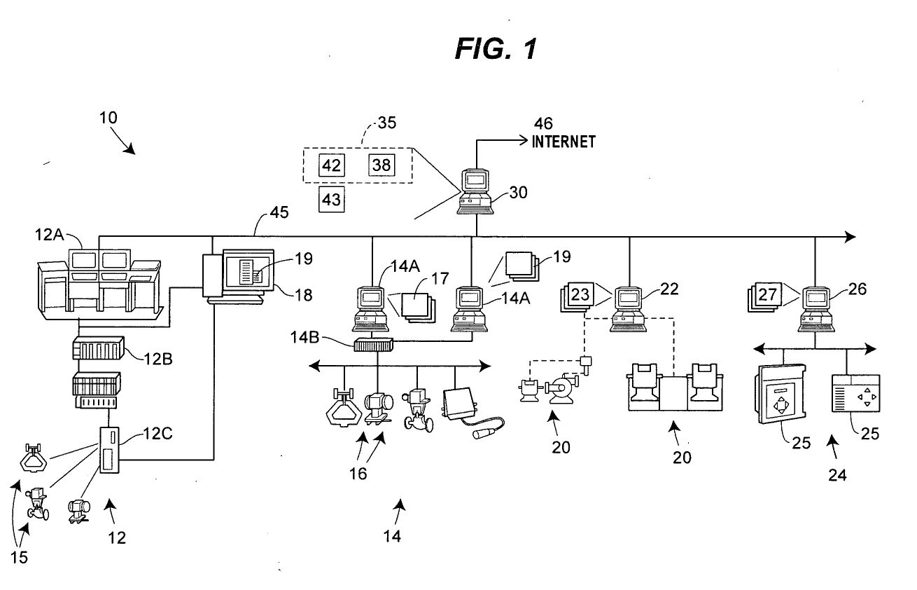

Referring now to FIG. 1, an example process plant 10 in which an abnormal situation prevention system may be implemented includes a number of control and maintenance systems interconnected together with supporting equipment via one or more communication networks. In particular, the process plant 10 of FIG. 1 includes one or more process control systems 12 and 14. The process control system 12 may be a traditional process control system such as a PROVOX or RS3 system or any other control system which includes an operator interface 12A coupled to a controller 12B and to input/output (I/O) cards 12C which, in turn, are coupled to various field devices such as analog and Highway Addressable Remote Transmitter (HART) field devices 15. The process control system 14, which may be a distributed process control system, includes one or more operator interfaces 14A coupled to one or more distributed controllers 14B via a bus, such as an Ethernet bus. The controllers 14B may be, for example, DeltaV™ controllers sold by Emerson Process Management of Austin, Tex. or any other desired type of controllers. The controllers 14B are connected via I/O devices to one or more field devices 16, such as for example, HART or Fieldbus field devices or any other smart or non-smart field devices including, for example, those that use any of the PROFIBUS®, WORLDFIP®, Device-Net®, AS-Interface and CAN protocols. As is known, the field devices 16 may provide analog or digital information to the controllers 14B related to process variables as well as to other device information. The operator interfaces 14A may store and execute tools available to the process control operator for controlling the operation of the process including, for example, control optimizers, diagnostic experts, neural networks, tuners, etc.

Still further, maintenance systems, such as computers executing the AMS application or any other device monitoring and communication applications may be connected to the process control systems 12 and 14 or to the individual devices therein to perform maintenance and monitoring activities. For example, a maintenance computer 18 may be connected to the controller 12B and/or to the devices 15 via any desired communication lines or networks (including wireless or handheld device networks) to communicate with and, in some instances, reconfigure or perform other maintenance activities on the devices 15. Similarly, maintenance applications such as the AMS application may be installed in and executed by one or more of the user interfaces 14A associated with the distributed process control system 14 to perform maintenance and monitoring functions, including data collection related to the operating status of the devices 16.

The process plant 10 also includes various rotating equipment 20, such as turbines, motors, etc. which are connected to a maintenance computer 22 via some permanent or temporary communication link (such as a bus, a wireless communication system or hand held devices which are connected to the equipment 20 to take readings and are then removed). The maintenance computer 22 may store and execute known monitoring and diagnostic applications 23 provided by, for example, CSI (an Emerson Process Management Company) or other any other known applications used to diagnose, monitor and optimize the operating state of the rotating equipment 20. Maintenance personnel usually use the applications 23 to maintain and oversee the performance of rotating equipment 20 in the plant 10, to determine problems with the rotating equipment 20 and to determine when and if the rotating equipment 20 must be repaired or replaced. In some cases, outside consultants or service organizations may temporarily acquire or measure data pertaining to the equipment 20 and use this data to perform analyses for the equipment 20 to detect problems, poor performance or other issues effecting the equipment 20. In these cases, the computers running the analyses may not be connected to the rest of the system 10 via any communication line or may be connected only temporarily.

Similarly, a power generation and distribution system 24 having power generating and distribution equipment 25 associated with the plant 10 is connected via, for example, a bus, to another computer 26 which runs and oversees the operation of the power generating and distribution equipment 25 within the plant 10. The computer 26 may execute known power control and diagnostics applications 27 such a as those provided by, for example, Liebert and ASCO or other companies to control and maintain the power generation and distribution equipment 25. Again, in many cases, outside consultants or service organizations may use service applications that temporarily acquire or measure data pertaining to the equipment 25 and use this data to perform analyses for the equipment 25 to detect problems, poor performance or other issues effecting the equipment 25. In these cases, the computers (such as the computer 26) running the analyses may not be connected to the rest of the system 10 via any communication line or may be connected only temporarily.

As illustrated in FIG. 1, a computer system 30 implements at least a portion of an abnormal situation prevention system 35, and in particular, the computer system 30 stores and implements a configuration application 38 and, optionally, an abnormal operation detection system 42, which will be described in more detail below. Additionally, the computer system 30 may implement an alert/alarm application 43.

Generally speaking, the abnormal situation prevention system 35 may communicate with abnormal operation detection systems (not shown in FIG. 1) optionally located in the field devices 15, 16, the controllers 12B, 14B, the rotating equipment 20 or its supporting computer 22, the power generation equipment 25 or its supporting computer 26 and any other desired devices and equipment within the process plant 10, and/or the abnormal operation detection system 42 in the computer system 30, to configure each of these abnormal operation detection systems and to receive information regarding the operation of the devices or subsystems that they are monitoring. The abnormal situation prevention system 35 may be communicatively connected via a hardwired bus 45 to each of the computers or devices within the plant 10 or, alternatively, may be connected via any other desired communication connection including, for example, wireless connections, dedicated connections which use OPC, intermittent connections, such as ones which rely on handheld devices to collect data, etc. Likewise, the abnormal situation prevention system 35 may obtain data pertaining to the field devices and equipment within the process plant 10 via a LAN or a public connection, such as the Internet, a telephone connection, etc. (illustrated in FIG. 1 as an Internet connection 46) with such data being collected by, for example, a third party service provider. Further, the abnormal situation prevention system 35 may be communicatively coupled to computers/devices in the plant 10 via a variety of techniques and/or protocols including, for example, Ethernet, Modbus, HTML, XML, proprietary techniques/protocols, etc. Thus, although particular examples using OPC to communicatively couple the abnormal situation prevention system 35 to computers/devices in the plant 10 are described herein, one of ordinary skill in the art will recognize that a variety of other methods of coupling the abnormal situation prevention system 35 to computers/devices in the plant 10 can be used as well.

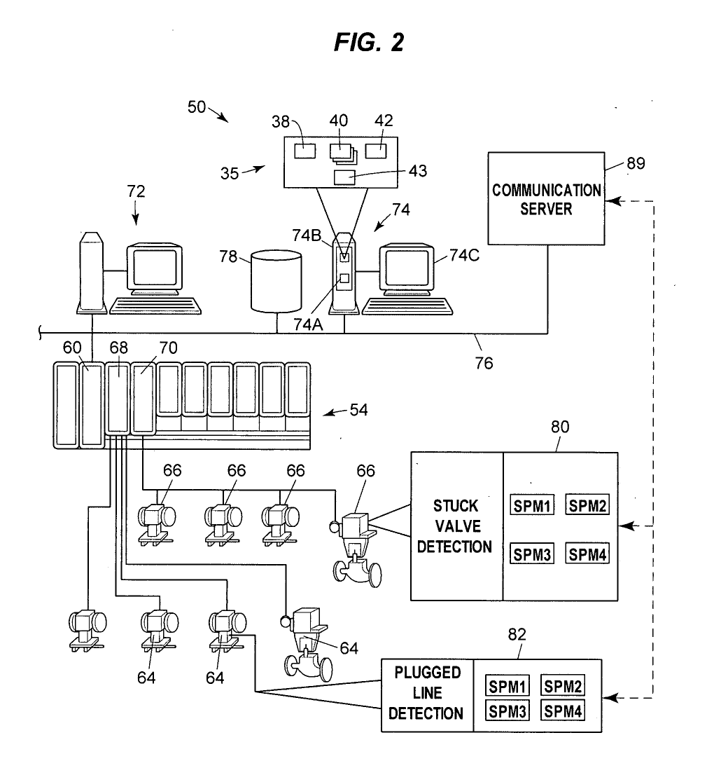

FIG. 2 illustrates a portion 50 of the example process plant 10 of FIG. 1 for the purpose of describing one manner in which statistical data collection may be performed by the abnormal situation prevention system 35. While FIG. 2 illustrates communications between the abnormal situation prevention system applications 38, 40 and 42 and the database 43 and one or more data collection blocks within HART and Fieldbus field devices, it will be understood that similar communications can occur between the abnormal situation prevention system applications 38, 40 and 42 and other devices and equipment within the process plant 10, including any of the devices and equipment illustrated in FIG. 1.

The portion 50 of the process plant 10 illustrated in FIG. 2 includes a distributed process control system 54 having one or more process controllers 60 connected to one or more field devices 64 and 66 via input/output (I/O) cards or devices 68 and 70, which may be any desired types of I/O devices conforming to any desired communication or controller protocol. The field devices 64 are illustrated as HART field devices and the field devices 66 are illustrated as Fieldbus field devices, although these field devices could use any other desired communication protocols. Additionally, the field devices 64 and 66 may be any types of devices such as, for example, sensors, valves, transmitters, positioners, etc., and may conform to any desired open, proprietary or other communication or programming protocol, it being understood that the I/O devices 68 and 70 must be compatible with the desired protocol used by the field devices 64 and 66.

In any event, one or more user interfaces or computers 72 and 74 (which may be any types of personal computers, workstations, etc.) accessible by plant personnel such as configuration engineers, process control operators, maintenance personnel, plant managers, supervisors, etc. are coupled to the process controllers 60 via a communication line or bus 76 which may be implemented using any desired hardwired or wireless communication structure, and using any desired or suitable communication protocol such as, for example, an Ethernet protocol. In addition, a database 78 may be connected to the communication bus 76 to operate as a data historian that collects and stores configuration information as well as on-line process variable data, parameter data, status data, and other data associated with the process controllers 60 and field devices 64 and 66 within the process plant 10. Thus, the database 78 may operate as a configuration database to store the current configuration, including process configuration modules, as well as control configuration information for the process control system 54 as downloaded to and stored within the process controllers 60 and the field devices 64 and 66. Likewise, the database 78 may store historical abnormal situation prevention data, including statistical data collected by the field devices 64 and 66 within the process plant 10, statistical data determined from process variables collected by the field devices 64 and 66, and other types of data.

While the process controllers 60, I/O devices 68 and 70, and field devices 64 and 66 are typically located down within and distributed throughout the sometimes harsh plant environment, the workstations 72 and 74, and the database 78 are usually located in control rooms, maintenance rooms or other less harsh environments easily accessible by operators, maintenance personnel, etc.

Generally speaking, the process controllers 60 store and execute one or more controller applications that implement control strategies using a number of different, independently executed, control modules or blocks. The control modules may each be made up of what are commonly referred to as function blocks, wherein each function block is a part or a subroutine of an overall control routine and operates in conjunction with other function blocks (via communications called links) to implement process control loops within the process plant 10. As is well known, function blocks, which may be objects in an object-oriented programming protocol, typically perform one of an input function, such as that associated with a transmitter, a sensor or other process parameter measurement device, a control function, such as that associated with a control routine that performs PID, fuzzy logic, etc. control, or an output function, which controls the operation of some device, such as a valve, to perform some physical function within the process plant 10. Of course, hybrid and other types of complex function blocks exist, such as model predictive controllers (MPCs), optimizers, etc. It is to be understood that while the Fieldbus protocol and the DeltaV™ system protocol use control modules and function blocks designed and implemented in an object-oriented programming protocol, the control modules may be designed using any desired control programming scheme including, for example, sequential function blocks, ladder logic, etc., and are not limited to being designed using function blocks or any other particular programming technique.

As illustrated in FIG. 2, the maintenance workstation 74 includes a processor 74A, a memory 74B and a display device 74C. The memory 74B stores the abnormal situation prevention applications 38, 40 and 42 discussed with respect to FIG. 1 in a manner that these applications can be implemented on the processor 74A to provide information to a user via the display 74C (or any other display device, such as a printer).

As illustrated in FIG. 2, the maintenance workstation 74 includes a processor 74A, a memory 74B and a display device 74C. The memory 74B stores the abnormal situation prevention application 35 and the alert/alarm application 43 discussed with respect to FIG. 1 in a manner that these applications can be implemented on the processor 74A to provide information to a user via the display 74C (or any other display device, such as a printer).

Each of one or more of the field devices 64 and 66 may include a memory (not shown) for storing routines such as routines for implementing statistical data collection pertaining to one or more process variables sensed by sensing device and/or routines for abnormal operation detection, which will be described below. Each of one or more of the field devices 64 and 66 may also include a processor (not shown) that executes routines such as routines for implementing statistical data collection and/or routines for abnormal operation detection. Statistical data collection and/or abnormal operation detection need not be implemented by software. Rather, one of ordinary skill in the art will recognize that such systems may be implemented by any combination of software, firmware, and/or hardware within one or more field devices and/or other devices.

As shown in FIG. 2, some (and potentially all) of the field devices 64 and 66 include abnormal operation detection blocks 80 and 82, which will be described in more detail below. While the blocks 80 and 82 of FIG. 2 are illustrated as being located in one of the devices 64 and in one of the devices 66, these or similar blocks could be located in any number of the field devices 64 and 66, could be located in other devices, such as the controller 60, the I/O devices 68, 70 or any of the devices illustrated in FIG. 1. Additionally, the blocks 80 and 82 could be in any subset of the devices 64 and 66.

Generally speaking, the blocks 80 and 82 or sub-elements of these blocks, collect data, such a process variable data, within the device in which they are located and perform statistical processing or analysis on the data for any number of reasons. For example, the block 80, which is illustrated as being associated with a valve, may have a stuck valve detection routine which analyzes the valve process variable data to determine if the valve is in a stuck condition. In addition, the block 80 includes a set of four statistical process monitoring (SPM) blocks or units SPM1-SPM4 which may collect process variable or other data within the valve and perform one or more statistical calculations on the collected data to determine, for example, a mean, a median, a standard deviation, a root-mean-square (RMS), a rate of change, a minimum, a maximum, etc. of the collected data. The specific statistical data generated, nor the method in which it is generated is not critical. Thus, different types of statistical data can be generated in addition to, or instead of, the specific types described above. Additionally, a variety of techniques, including known techniques, can be used to generate such data. The term statistical process monitoring (SPM) block is used herein to describe functionality that performs statistical process monitoring on at least one process variable or other process parameter, and may be performed by any desired software, firmware or hardware within the device or even outside of a device for which data is collected. It will be understood that, because the SPMs are generally located in the devices where the device data is collected, the SPMs can acquire quantitatively more and qualitatively more accurate process variable data. As a result, the SPM blocks are generally capable of determining better statistical calculations with respect to the collected process variable data than a block located outside of the device in which the process variable data is collected.

It is to be understood that although the blocks 80 and 82 are shown to include SPM blocks in FIG. 2, the SPM blocks may instead be stand-alone blocks separate from the blocks 80 and 82, and may be located in the same device as the corresponding block 80 or 82 or may be in a different device. The SPM blocks discussed herein may comprise known Foundation Fieldbus SPM blocks, or SPM blocks that have different or additional capabilities as compared with known Foundation Fieldbus SPM blocks. The term statistical process monitoring (SPM) block is used herein to refer to any type of block or element that collects data, such as process variable data, and performs some statistical processing on this data to determine a statistical measure, such as a mean, a standard deviation, etc. As a result, this term is intended to cover software, firmware, hardware and/or other elements that perform this function, whether these elements are in the form of function blocks, or other types of blocks, programs, routines or elements and whether or not these elements conform to the Foundation Fieldbus protocol, or some other protocol, such as Profibus, HART, CAN, etc. protocol. If desired, the underlying operation of blocks 50 may be performed or implemented at least partially as described in U.S. Pat. No. 6,017,143, which is hereby incorporated by reference herein.

It is to be understood that although the blocks 80 and 82 are shown to include SPM blocks in FIG. 2, SPM blocks are not required of the blocks 80 and 82. For example, abnormal operation detection routines of the blocks 80 and 82 could operate using process variable data not processed by an SPM block. As another example, the blocks 80 and 82 could each receive and operate on data provided by one or more SPM block located in other devices. As yet another example, the process variable data could be processed in a manner that is not provided by many typical SPM blocks. As just one example, the process variable data could be filtered by a finite impulse response (FIR) or infinite impulse response (IIR) filter such as a bandpass filter or some other type of filter. As another example, the process variable data could be trimmed so that it remained in a particular range. Of course, known SPM blocks could be modified to provide such different or additional processing capabilities.

The block 82 of FIG. 2, which is illustrated as being associated with a transmitter, may have a plugged line detection unit that analyzes the process variable data collected by the transmitter to determine if a line within the plant is plugged. In addition, the block 82 may includes one or more SPM blocks or units such as blocks SPM1-SPM4 which may collect process variable or other data within the transmitter and perform one or more statistical calculations on the collected data to determine, for example, a mean, a median, a standard deviation, etc. of the collected data. While the blocks 80 and 82 are illustrated as including four SPM blocks each, the blocks 80 and 82 could have any other number of SPM blocks therein for collecting and determining statistical data.

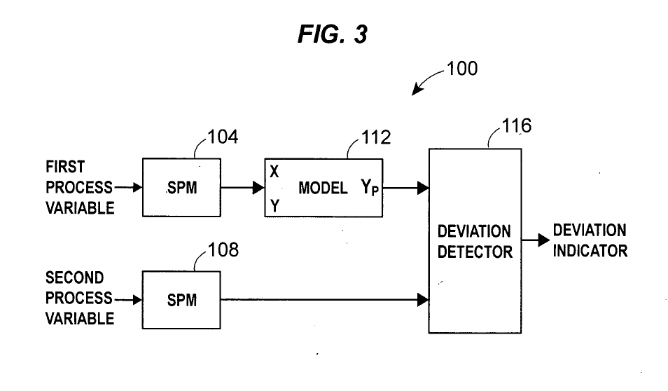

FIG. 3 is a block diagram of an example abnormal situation prevention system 100 that could be utilized in the abnormal situation prevention blocks 80 and 82 of FIG. 2. The abnormal situation prevention system 100 includes a first SPM block 104 and a second SPM block 108 coupled to a model 112. The first SPM block 104 receives a first process variable and generates first statistical data from the first process variable. The first statistical data could be any of various kinds of statistical data such as mean data, median data, standard deviation data, rate of change data, range data, etc., calculated from the first process variable. Such data could be calculated based on a sliding window of first process variable data or based on non-overlapping windows of first process variable data. As one example, the first SPM block 104 may generate mean data using a most recent first process variable sample and 49 previous samples of the first process variable. In this example, a mean variable value may be generated for each new first process variable sample received by the first SPM block 104. As another example, the first SPM block 104 may generate mean data using non-overlapping time periods. In this example, a window of five minutes (or some other suitable time period) could be used, and a mean variable value would thus be generated every five minutes. In a similar manner, the second SPM block 108 receives a second process variable and generates second statistical data from the second process variable in a manner similar to the SPM block 104.

The model 112 includes inputs for receiving values of an independent variable x and a dependent variable y. The model 112 may be trained using a plurality of (x, y) data sets to model the dependent variable y as a function of the independent variable x. The model 112 may include a regression model. The regression model utilizes a function to model the dependent variable y as a function of the independent variable x over some range of x. The regression model may be a linear regression model, or some other regression model. A linear regression model may comprise a first order function of x (e.g., y=a₀+a₁x), a second order function of x (e.g., y=a₀+a₁x+a₂x²), or a polynomial of some other order p (e.g., y=a₀+a₁x+a₂x²+ . . . +aₚx^{p}).

After it has been trained, the model 112 may be used to generate a predicted value (y_{P}) of a dependent variable y based on a given input value of the independent variable x. The predicted value of the dependent variable output y_{P} is provided to a deviation detector 116. The deviation detector 116 receives the predicted value of the dependent variable yₚ as well as the actual value of the dependent variable y corresponding the to the input value of the independent variable x. The deviation detector 116 compares the actual value of the dependent variable y to the predicted value of the dependent value y_{P} to determine whether the value of the dependent variable y varies significantly from the predicted value of the dependent variable y_{P}. If the value of the dependent variable y is significantly different from the predicted value of the dependent variable y_{P}, an abnormal situation may have occurred, is occurring, or may occur in the near future. In these circumstances the deviation detector 116 may generate a deviation indicator indicating the presence of an abnormal situation. In some implementations, the indicator may comprise an alert or alarm.

The abnormal situation prevention system 100 could be implemented wholly or partially in a field device. As just one example, the SPM blocks 104 and 108 could be implemented in a field device 66 and the model 112 and/or the deviation detector 116 could be implemented in the controller 60 or some other device. In one particular implementation, the abnormal situation prevention system 100 could be implemented as a function block, such as a function block to be used in a system that implements the fieldbus protocol. Such a function block may or may not include the SPM blocks 104 and 108. In another implementation, each of at least some of the blocks 104, 108, 112, and 116 may be implemented as a function block.

As described above, many abnormal situation prevention algorithms rely on a linear regression to model a monitored variable as a function of a corresponding load variable. The regression model is fashioned from a set of training data containing a number of corresponding samples of the load and monitored variables measured from the controlled process. The regression model comprises a function or curve that best fits the data in the training set. The regression model may comprise a polynomial function of a specified order p. For example, the regression model may comprise a linear, second order (quadratic), third order (cubic), or fourth-order polynomial function, and so forth.

In general, the higher the order of polynomial function, the better the regression model will fit the training data. However, it is possible that a polynomial regression model may “over-fit” the training data. A model that over-fits the training data fits the points in the training set very well, but may not prove to be particularly accurate at predicting values of the monitored variable during the monitoring phase. At some point there is a trade-off between generating a model that accurately represents the data in the relatively small training set and a model that represents the data in the training set in a more general way that is more accurate in making predictions regarding a much larger data set that will be gathered during the monitoring phase.

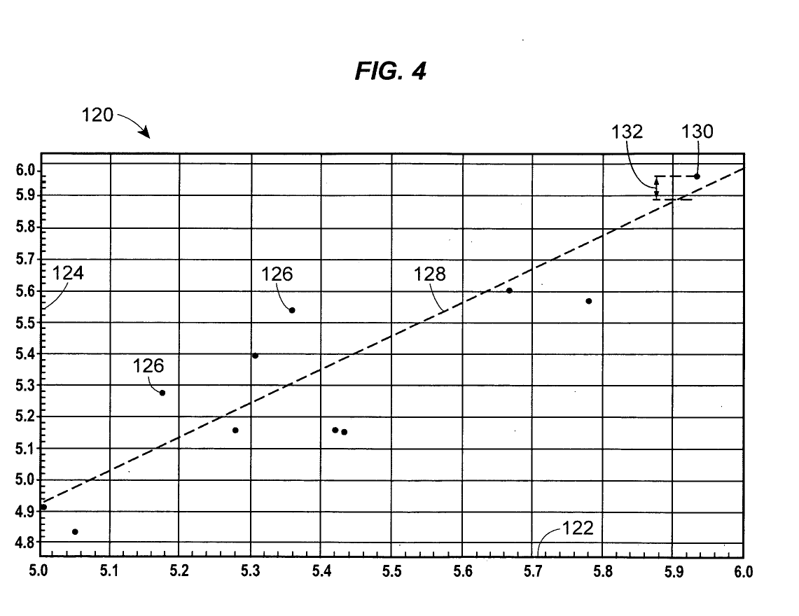

For example, FIG. 4 shows a first order polynomial regression for a sample training data set. An x-y coordinate system 120 includes a horizontal axis 122 and a vertical axis 124. The horizontal axis 122 represents values of the independent variable x, and the vertical axis 124 represents values of the dependent variable y. The training data comprise a plurality of (x, y) points 126 shown plotted on the x-y coordinate system 120. As can be seen, the data points 126 exhibit a general upward trend, with the value of the dependent variable y generally increasing for higher values of the independent variable. This trend is not exact, however, and there are several examples of data points in which the value of the independent variable y is less than that of neighboring points, even though the point may have a higher value of the independent variable. Nonetheless, the general trend is upward, and the first order polynomial regression 128 reflects this trend. Note that the first order regression 128 is not exactly accurate. None of the data points 126 actually lie on the regression curve 128. In fact many of the points are a significant distance from the regression curve 128. Nonetheless, the curve 128 accurately reflects the general trend in the data.

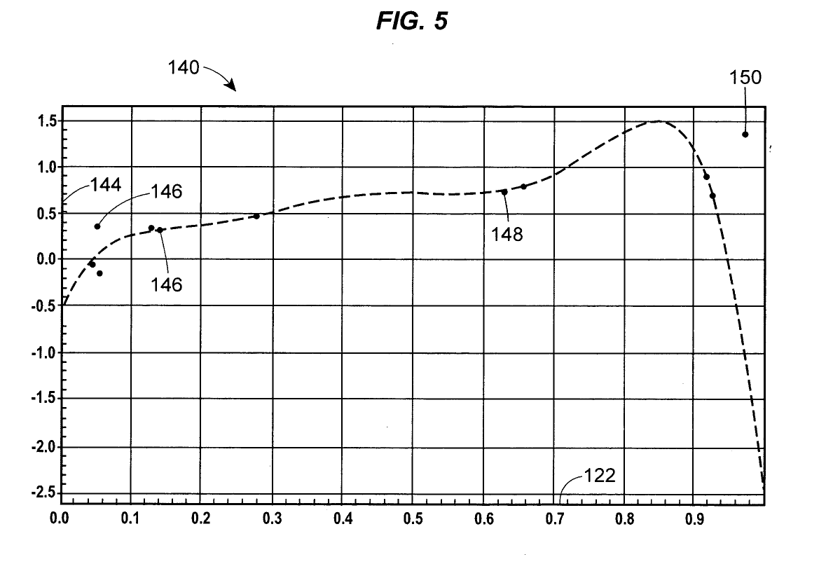

FIG. 5 shows a sixth order polynomial regression for another set of training data. Again an x-y coordinate system 140 includes a horizontal axis 142 and a vertical axis 144. The horizontal axis 142 represents values of the independent variable x and the vertical axis 144 represents values of the dependent variable y. The training data comprise a plurality of (x, y) points 146 shown plotted on the x-y coordinate system 140. Again, the data exhibit a slight upward trend, with the dependent variable y showing generally higher values with increasing values of the independent variable x. The sixth order polynomial 148 fits the data quite closely. In fact, many of the data points 146 fall substantially on the sixth order regression curve 148. The close fit between the data points 146 and the regression curve 148, however, comes at a price. The general upward trend in the data is not nearly as visible in the sixth order polynomial regression curve 148 as it is in the first order polynomial regression curve 128 shown in FIG. 4. In fact, looking solely at the sixth order polynomial regression curve one would be led to believe that the values of the dependent variable y drop to 0 for higher values of the dependent variable x, whereas a simple visual assessment of the data makes clear that the upward trend in the data continues even for the higher values of the independent variable.

The sixth order polynomial regression 148 shown in FIG. 5 is said to “over-fit” the data. The sixth order polynomial 148 describes the data in the training set almost exactly, but will be of little use for predicting values of the dependent variable as new data points are received. Such predictions will be especially poor for new data points with large independent variable x values. Consider a new data point 150 shown in FIG. 5. The point 150 located in the upper right hand corner of the coordinate system 140 has large values for both the independent and dependent variables x and y corresponding to the general trend of the other data points 146 in the training set. Yet, based on the sixth order polynomial regression 148, one would predict that the value of the dependent variable of the new point would be very small, nearly zero. Thus, it is clear that the sixth order polynomial regression 148 would not accurately predict the value of the dependent variable y of the new data point 150 or other similarly placed data points.

Comparing the first order regression model 128 of FIG. 4 with the regression model 148 of FIG. 5, it appears that the first order regression model 128 would be of more use in predicting values of the dependent variable for data points received in the future. There may be circumstances, however, in which it is desirable to have a polynomial regression that vary accurately reflects the training data. In order to create a valid model that may be successfully employed to accurately detect and in some cases predict and prevent abnormal situations from occurring, whoever selects the order of the polynomial regression should be somewhat familiar with the process being controlled and should have some understanding of the consequences of selecting a polynomial regression of a certain order.

In many abnormal situation prevention systems employing a polynomial regression model the order of the polynomial regression is a user-specified parameter. However, because improper selection of the polynomial order may result in inaccurate predictions, and therefore inaccurate detection of abnormal process events, it may be desirable to automatically select the order of the polynomial regression based on the nature of the data in the training set. As will be described below, a number of different methods may be employed for determining an appropriate order of a polynomial regression for modeling the data in a set of training data. An embodiment of an abnormal situation prevention system may employ substantially any algorithm or method for determining an appropriate order of a polynomial regression model.

A first method that may be employed for determining the order of a polynomial is known as cross-validation. Consider a training set of n (x, y) data samples, where x comprises the independent or load variable and y comprises the dependent or monitored variable. The training set may be divided into two subsets, a training subset comprising nₜ samples, and a validation subset comprising n, samples. The training samples and the validation samples comprise all of the samples in the training set such that nₜ+nᵥ=n. The sample in the training subset may be identified as (x_{t,i}, y_{t,i}), i=1, 2, . . . , nₜ. The samples in the validation subset may be identified as (x_{v,i}, y_{v,i}), i=1, 2, . . . , nᵥ. The samples in the training subset may be used to calculate the polynomial regression model, and the samples in the validation subset may be used to determine how well the calculated regression model will predict future data.

The regression coefficients a₀, a₁, . . . , aₚ of a polynomial regression model of the order p may be calculated from the samples in the training subset according to the formula:

$$[ \begin{matrix}{a}_{0} \\ {a}_{1} \\ ⋯ \\ {a}_{p}\end{matrix} ] = {[ \begin{matrix}n & {\sum }_{i = 1}^{n} {x}_{t , i} & ⋯ & {\sum }_{i = 1}^{n} {x}_{t , i}^{p} \\ {\sum }_{i = 1}^{n} {x}_{t , i} & {\sum }_{i = 1}^{n} {x}_{t , i}^{2} & ⋯ & {\sum }_{i = 1}^{n} {x}_{t , i}^{p + 1} \\ ⋯ & ⋯ & ⋯ & ⋯ \\ {\sum }_{i = 1}^{n} {x}_{t , i}^{p} & {\sum }_{i = 1}^{n} {x}_{t , i}^{p + 1} & ⋯ & {\sum }_{i = 1}^{n} {x}_{t , i}^{2 p}\end{matrix} ]}^{- 1} [ \begin{matrix}{\sum }_{i = 1}^{n} {y}_{t , i} \\ {\sum }_{i = 1}^{n} {x}_{t , i} {y}_{t , i} \\ ⋯ \\ {\sum }_{i = 1}^{n} {x}_{t , i}^{p} {y}_{t , i}\end{matrix} ] .$$

Once the coefficients a₀, a₁, . . . , aₚ have been calculated for a polynomial regression of order p, the model may be applied to the samples in the validation subset to determine how well the polynomial regression predicts future values of the dependent (monitored) variable y based on the received values of the independent (load) variable x. For every sample in the validation set (x_{v,i}, y_{v,i}), i=1, 2, . . . , nᵥ, a predicted value of the dependent variable ŷ_{v,i} may be calculated according to the formula:

ŷ_{v,i}=a₀+a₁x_{v,i}+ . . . aₚx_{v,i}^{p} for i=1, 2 . . . nᵥ.

Furthermore, the prediction error for every data point in the validation subset may be determined by calculating the difference between the predicted value of the dependent variable ŷ_{v,i} and the corresponding actual value of the dependent variable y_{v,i} according to the formula:

E_{v,i}=ŷ_{v,i}−y_{v,i}.

The overall accuracy of the model may be evaluated based on the mean square error for all data points in the validation subset. The mean square error for all data points in the validation subset may be calculated according to the formula:

$$M S {E}_{v} = \frac{1}{{n}_{v}} {\sum }_{i = 1}^{{n}_{v}} {( {\hat{y}}_{v , i} - {y}_{v , i} )}^{2} .$$

According to this first method for determining the optimal order of a polynomial regression, a polynomial regression model may be calculated for every polynomial order from 1 to pₘₐₓ using the training subset. The corresponding mean square error (MSEᵥ) may be calculated for each polynomial to determine how well each polynomial fits the validation data. The order of the polynomial regression resulting in the smallest mean square error may be selected as the optimal order for the polynomial regression for the abnormal situation prevention application.

In order to improve results and to ensure that all of the available training data are used to determine the optimal order of the regression polynomial, the above described procedure may be repeated several times, each time using different portions of the training data as the training and validation subsets. For example, the k-fold cross-validation technique may be employed to divide the training data into a number of different subsets that may be recombined in various combinations to form the training and validation subsets employed for calculating a polynomial regression model and testing its validity as described above. According to the k-fold cross-validation technique, the training data set may be divided into a number k of approximately equal subsets. The number k may equal, for example, 5 or some other number. For each polynomial regression order p (p=1, 2, . . . , pₘₐₓ) the cross-validation technique is repeated k times. Each time a different one of the k subsets of the training data is used as the validation subset and the remaining k-1 subsets of the training data are used for calculating the regression model. In this case, the mean square error (MSEᵥ) for a given order polynomial regression is equal to the sum of all k MSEᵥ calculations (i.e., one component from each of the k subsets of validation data). An alternative validation technique that may be employed is leave-one-out cross-validation. This is essentially a special case of the k-fold cross-validation technique in which k equals the total number of samples in the training set (k=n) and the size each subset is equal to 1.

Additional methods for determining the optimal order of a polynomial regression may be based on analytical methods of complexity control. Such methods may be based on minimizing a penalized risk functional of the form:

R_{PENALTY}(ω)=R_{EMP}(ω)+λφ[f(x,ω)]

where
ω represents the parameters of a model. In the case of a polynomial regression model, ω represents the polynomial regression coefficients a₀, a₁, . . . , aₚ.
R_{EMP}(ω) represents the empirical risk of the model. In the case of a polynomial regression, the empirical risk may be defined as the sum of the squares of the errors between predicted and actual values of the dependent variable y for all data points in the training data set.
φ[f(x,ω)] is a penalization function. The penalization function is used to assess the complexity of the model. In the case of polynomial regression the penalization function is characterized by having a higher value for higher order polynomials, or for polynomials having larger coefficients a₀, a₁, . . . , aₚ.
λ is a complexity control factor. λ is used to determine the relative importance between minimizing the error between predicted values of the dependent variable and corresponding actual values of the dependent variable in the training set and minimizing the complexity of the model. For smaller values of λ minimizing the error between predicted and actual values of the dependent variable y will take on greater significance, whereas for higher values of λ minimizing the complexity of the model will take precedence.

The Ridge function is a popular penalty function that may be readily applied to polynomial regression. Employing the ridge function,

$$φ [ f ( x , ω ) ] = η ( \vec{a} ) = {\sum }_{i = 0}^{p} {a}_{i}^{2}$$

The penalized risk functional for a polynomial regression of order P becomes

$${R}_{PEN} ( P , \vec{a} ) = {\sum }_{i = 1}^{n} {[ {y}_{i} - ( {a}_{0} + {a}_{1} {x}_{i} + {a}_{2} {x}_{i}^{2} + … + {a}_{p} {x}^{p} ) ]}^{2} + λ {\sum }_{i = 0}^{p} {a}_{i}^{2}$$

This is known as a Ridge Regression. At this point it is still necessary to determine an appropriate value for the complexity control factor λ. This could be done empirically based on numerous trials with a plurality of different training data sets. Once an appropriate value of λ has been determined it will likely apply across many different situations. For a given order polynomial regression, the Ridge Regression can be evaluated numerically. In order to determine the optimal order of a polynomial regression for a particular set of training data, the Ridge Regression must be evaluated for each value of p=1, 2, . . . , pₘₐₓ. The optimal order p of the polynomial regression will be the value of p for which the penalized risk functional is a minimum.

Yet another method for automatically determining the optimal order of a polynomial regression model is to calculate an R² value for polynomial regressions of every polynomial order from p=1 to pₘₐₓ, for a particular training data set. R² is a measure of how well a polynomial regression fits the data in a training set. The R² value is calculated by dividing the sum of the square of the difference between the predicted value of the dependent variable and the average of the actual values of the dependent variable for every point in the data set by the sum of the square of the difference between the actual value of the dependent variable and the average value of the dependent variable for every point in the data set. Thus, the R² value may be calculated according to the formula:

$${R}^{2} = \frac{{\sum }_{i = 1}^{n} {( {\hat{y}}_{i} - \overline{y} )}^{2}}{{\sum }_{i = 1}^{n} {( {y}_{i} - \overline{y} )}^{2}} .$$

The average value of the dependent variable y̅ over the entire training data set is given by:

$${\overline{y}}_{t} = \frac{1}{n} {\sum }_{i = 1}^{n} {y}_{i} .$$

And each predicted value of the dependent variable yᵢ is given by:

$${\hat{y}}_{t} = {a}_{0} + {a}_{1} {x}_{i} + … {a}_{p} {x}_{i}^{p} = {\sum }_{j = 0}^{p} {a}_{j} {x}_{i}^{j} .$$

According to this method, a polynomial regression may be performed for all polynomial orders p=1, 2, . . . , pₘₐₓ, and a corresponding R² value may be calculated for each polynomial regression. As mentioned above, R² is a measure of how well a polynomial regression fits the training data set. If the R² value is near 1, there is a good fit between the regression curve and the data. If R² is near 0, there is little or no fit between the regression curve and the data.

The optimal order of the polynomial regression is determined by comparing the R² values associated with each polynomial regression calculated for each possible polynomial order p=1, 2, . . . , pₘₐₓ. The optimal order for a polynomial regression model may be identified as the order of the polynomial regression for which polynomial regressions of a higher order show no significant improvement in their corresponding R² values. “No significant improvement” may be defined in many different ways. For example, there may be no significant improvement between a polynomial regression of an order p and a polynomial regression of the next highest order p+1 if the difference between the R² value calculated for the polynomial regression of order p and the R² value of the polynomial regression of order p+1 is less than a predefined threshold

$$( e . g . {R}_{p + 1}^{2} - {R}_{p}^{2} < 0.01 ) .$$

In this case, the order of the lower order polynomial may be selected as the optimal order of the polynomial regression model for the abnormal situation prevention application. Another way to define “no significant improvement” might be to look at the changes in the R² values from each successive polynomial regression (in the order of increasing values of p) and identifying the step from one polynomial regression to the next in which the difference in R² values is significantly less (e.g., less than 10%) of the difference in R² values from the previous two successive polynomial regressions. For example, assume the R² value calculated for a second order polynomial regression is 0.4, the R² value of a 3^{rd} order polynomial regression is 0.7, and the R² value of a 4^{th} order polynomial regression is 0.72. The difference in the R² value between the third and fourth order polynomial regressions, 0.02, is only 6% of the difference between the R² values of the 2^{nd} and 3^{rd} order polynomial regressions. Since the difference in the R² value going from a third order polynomial regression to a fourth order polynomial is less than 10% of the difference in the R² values going from a 2^{nd} order polynomial regression to a 3^{rd} order polynomial repression, the 3^{rd} order polynomial regression may be considered the optimal order of the polynomial regression for the particular abnormal situation prevention application for which the polynomial regression model is being developed.

Support vector machines are another method by which regression models may be developed for abnormal situation prevention applications. Support vector machines are based on statistical learning theory and were originally developed for classification problems, but may also be extended to regression. Support vector regression (SVR) uses what is known as an ε-insensitive loss function. If the error between a model and a data point is less than some predetermined value ε then the error is considered 0 and the point does not contribute to the calculation of an error penalty. For errors greater than ε, however, the error penalty increases linearly according to the ε-insensitive loss function.

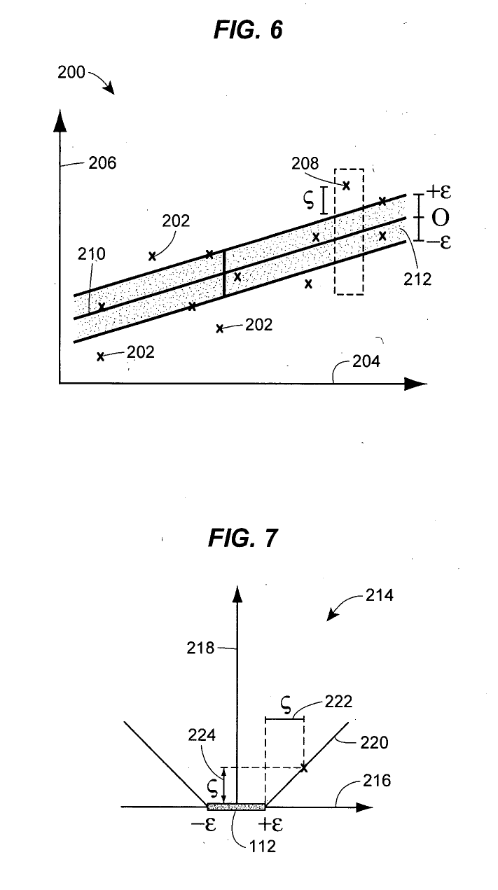

An example of a first order SVR model is shown in FIG. 6. A corresponding ε-insensitive loss function is shown in FIG. 7. In FIG. 6, a plurality of data points 202 are plotted in a coordinate system 200 in which the horizontal axis 204 represents values of the independent variable x and the vertical axis 206 represents values of the dependent variable y. A regression curve 210 is fitted to the data points 202. Further, a band 212±ε wide extends on both sides of the regression curve 210. In FIG. 7, the ε-insensitive loss function 220 is shown plotted in a coordinate system 214 in which the horizontal axis 216 represents the actual error between a data point and the regression curve 210. The vertical axis 218 represents the error penalty assessed for the data point according to the ε-insensitive loss function 220. As can be seen in FIG. 6 for errors between ±ε no error penalty is assessed. For errors greater than ε, however, the error penalty increases linearly on a one to one basis beyond ε. Consider the point 208 in FIG. 6. The total error between the point 208 and the regression model 210 (i.e. the vertical distance between the point 208 and the regression curve 210) is equal to ε plus some additional amount ξ. Turning to FIG. 7, the portion of the error less than ε does not contribute to the error penalty. Only the portion ξ 222 extending beyond ε contributes to the error penalty 224. Due to the one-to-one correspondence of the ε-insensitive loss function for error values greater than ε, the full amount of the error ξ 222 extending beyond ε-insensitive region 212 contributes to the error penalty 224. Thus, the support vector regression fits not just the first order regression curve 210 to the data set, but the entire band ±ε on either side of the regression curve 210. In many applications there will be some amount of noise in the data. By prudent selection of the value of ε it is possible to fashion a regression model that fits the data but is not affected by the noise.

In performing a support vector regression the expression:

$$\frac{1}{2} {‖ w ‖}^{2} + C {\sum }_{i = 1}^{n} ( {ξ}_{i} + {ξ}_{i}^{*} )$$

is minimized. The term

$$\frac{1}{2} {‖ w ‖}^{2}$$

represents the sum of all input weights. When applied to polynomial regression, these comprise the coefficients a₀, a₁, . . . aₚ. The term

$${\sum }_{i = 1}^{n} ( {ξ}_{i} + {ξ}_{i}^{*} )$$

is the sum of all of the losses outside the ε-insensitive region (i.e., all of the losses for points outside the ±ε band 212 surrounding the regression curve 210). C is a complexity control factor that determines the relative importance between minimizing the complexity of the model input weights and the total error of points outside the ε-insensitive region. The complexity control factor C must be user specified for each data set. Thus, there are two parameters that must be specified for implementing a support vector regression, ε and C. Methods may be employed for automatically selecting the values of these parameters based on the training data. These methods could be implemented as part of an algorithm for automatically determining the order of a polynomial regression.

SVR is simply another method for calculating the coefficients of a regression model. It does not, in and of itself, determine the optimal order p of a polynomial regression model for modeling a particular data set and making predictions regarding future data. Using SVR, the optimal order p of a polynomial regression may be determined by performing the SVR algorithm for all possible values of p, (p=1, 2, . . . , pₘₐₓ), in other words, creating a polynomial regression model for every possible polynomial order p from 1 to pₘₐₓ, The total error

$${\sum }_{i = 1}^{n} ( {ξ}_{i} + {ξ}_{i}^{*} )$$

as determined by the ε-insensitive loss function may be evaluated for each polynomial regression model. The polynomial regression of the optimal order p is either the polynomial regression for which the total error is 0, or the polynomial regression beyond which there is no significant improvement in the total error for polynomial regressions of higher orders. Again “no significant improvement” may be defined as situations in which the total error

$${\sum }_{i = 1}^{n} ( {ξ}_{i} + {ξ}_{i}^{*} )$$

changes by less than some predetermined amount between successive polynomial regressions, or when the total error improves by less than a certain percentage, and so forth.

In addition to the methods described above, there may be many other methods for automatically determining the optimal order of a polynomial regression that may be applied to abnormal situation prevention in a process plant. By automatically determining the optimal order of a polynomial regression, a user, such as a plant operator or other personnel, need not determine the optimal order and enter the value as a configuration parameter when setting up an abnormal situation prevention system. By determining the order of the polynomial regression automatically it is less likely that an inappropriate value will be selected, and the resulting polynomial regression model will be more likely to accurately predict the value of monitored process variables for purposes of detecting and/or preventing abnormal process events.

The methods for determining the order of a polynomial regression described herein may be implemented on many process control platforms. In fact, the methods may be implemented on substantially any intelligent process control device that has the processing power to implement the computationally intensive methods described above. A non-exclusive list of process control devices in which the various methods may be implemented includes field devices, Foundation™ fieldbus function or transducer blocks, field device interface modules, handheld communicators, controllers and control systems, stand alone software applications and so forth.

Thus, while the present disclosure has been described with reference to specific examples, which are intended to be illustrative only and not to be limiting, it will be apparent to those of ordinary skill in the art that changes, additions or deletions may be made to the disclosed embodiments without departing from the spirit and scope of the disclosure.

1. A process control system comprising:
at least one field device adapted to measure process control data associated with a first process control variable and a second process control variable; and
a processor adapted to determine an optimal order of a polynomial regression for modeling the second process control variable as a function of the first process control variable.

2. The process control system of claim 1, wherein the processor is adapted to execute a cross-validation algorithm for determining the optimal order of the polynomial regression.

3. The process control system of claim 1 wherein the processor is adapted to execute a penalty function for determining the optimal order of the polynomial regression.

4. The process control system of claim 3 wherein the penalty function comprises a Ridge Regression.

5. The process control system of claim 1 wherein the processor is adapted to execute a forward selection algorithm for determining the optimal order of the polynomial regression.

6. The process control system of claim 1 wherein the processor is adapted to calculate a first order polynomial regression and a polynomial regression of each subsequent polynomial order up to and including a maximum polynomial order based on the measured process control data, the processor further adapted to calculate R² values for each polynomial regression indicating how well each polynomial regression fits the measured process control data, and select the optimal polynomial regression order based on the calculated R² values.

7. The process control system of claim 1 wherein the processor is further adapted to execute a support vector machine for determining the optimal order of the polynomial regression.

8. The process control system of claim 7 wherein the processor is further adapted to generate a plurality of support vector machine models and to select a polynomial order for which a total error value as determined by a corresponding support vector machine model ε-insensitive loss function is zero.

9. The process control system of claim 1 wherein the processor adapted to determine the optimal order of the polynomial regression is implemented within one of: a process control field device; a field device interface module; a FOUNDATION™ fieldbus function block; a FOUNDATION™ fieldbus transducer block; a process control system; or a stand alone software application.

10. A method of creating a polynomial regression model of process control data for preventing abnormal situations in a controlled process, the method comprising:
receiving a set of training data comprising a plurality of first process control variable values and a plurality of corresponding second process control variable values;
determining an optimal order of a polynomial regression for modeling the second process control variable as a function of the first process control variable based on the values of the first process control variable and the second process control variable included in the received set of training data; and
creating a polynomial regression model of the determined order for modeling the second process control variable as a function of the first process control variable based on the values of the first and second process control variable values included in the received training set data.

11. The method of claim 10 wherein determining the optimal order of the polynomial regression comprises performing a cross validation algorithm on the received set of training data.

12. The method of claim 10 wherein determining the optimal order of the polynomial regression comprises minimizing a penalized risk function.

13. The method of claim 12 wherein the penalized risk function is a Ridge Regression.

14. The method of claim 10 wherein determining the optimal order of the polynomial regression comprises executing a forward selection algorithm.

15. The method of claim 10 wherein determining the optimal order of the polynomial regression comprises:
calculating a first order polynomial regression and a polynomial regression of each subsequent order up to and including a polynomial regression of a predefined maximum order based on the received a set of training data;
calculating an R² value for each of the first order polynomial regression and each subsequent ordered polynomial regression; and
determining the order of a first polynomial regression for which the R² value of a subsequent higher order polynomial regression differs from the R² value of the first polynomial regression by less than a predefined amount.

16. The method of claim 10 wherein determining the optimal order of the polynomial regression comprises executing a support vector machine.

17. The method of claim 16 wherein determining the optimal order of the polynomial regression comprises generating a plurality of support vector machine models and selecting a polynomial order for which a total error value as determined by a corresponding support vector machine model ε-insensitive loss function is zero.

18. The method of claim 10 wherein executing an algorithm for determining the optimal order of the polynomial regression is performed within one of: a process control field device; a FOUNDATION™ fieldbus function block; a FOUNDATION™ fieldbus transducer block; a field device interface module; a process control system; or a stand alone software application.

19. A system for detecting an abnormal situation in a process, the system comprising:
a first input for receiving first process variable data;
a second input for receiving second process variable data; and
a processor adapted to determine an optimal order of a polynomial regression for modeling the second variable data as a function of the first variable data; calculate a polynomial regression model having the determined optimal order; and employ the calculated polynomial regression model to detect the abnormal situation in the process plant.

20. The system of claim 19, wherein the processor is adapted to execute one of a cross-validation algorithm; penalty function minimization algorithm; or a forward selection algorithm for determining the optimal order of the polynomial regression.

21. The system of claim 19 wherein the processor is further adapted to utilize a support vector machine model for determining the optimal order of the polynomial regression.

22. The system of claim 19 wherein the processor is further adapted to calculate a polynomial regression on the process control data associated with the first and second process variables for all polynomial orders between and including a first order polynomial and a predetermined maximum polynomial order, calculate a measure of how well each polynomial regression fits the process control data and select the polynomial order of the polynomial regression that best fits the process control data.

23. The system of claim 22, wherein the measure of how well each polynomial regression fits the process control data comprises an R² value calculated for each polynomial regression according to the formula:
$${R}^{2} = \frac{{\sum }_{i = 1}^{n} {( {\hat{y}}_{i} - \overline{y} )}^{2}}{{\sum }_{i = 1}^{n} {( {y}_{i} - \overline{y} )}^{2}} .$$

24. The system of claim 23 wherein the optimal order of the polynomial regression is the order of the polynomial beyond which polynomials having a higher order show no significant improvement in their corresponding R² values.

25. The system of claim 19 wherein the processor adapted to determine the optimal order of the polynomial regression is implemented in one of a process control field device; a field device interface module; a FOUNDATION™ fieldbus function block; a FOUNDATION™ fieldbus transducer block; a process control system; or a stand alone software application.
